(19) United States
(12) Patent Application Publication
(10) Pub. No.: US 2016/0275039 A1
(43) Pub. Date: Sep. 22, 2016

(54) SEMICONDUCTOR INTEGRATED CIRCUIT DEVICE, ELECTRONIC APPARATUS USING THE SAME, CONTROL METHOD FOR CIRCUIT

(71) Applicant: SEIKO EPSON CORPORATION, Tokyo (JP)

(72) Inventor: Yasunobu TOKUDA, Okaya-shi (JP)

(73) Assignee: SEIKO EPSON CORPORATION, Tokyo (JP)

(21) Appl. No.: 15/059,631

(22) Filed: Mar. 3, 2016

(30) Foreign Application Priority Data
Mar. 16, 2015 (JP) 2015-051769

(51) Int. Cl. G06F 13/42; G06F 13/362

(52) U.S. Cl. CPC G06F 13/4282; G06F 13/362

(57) ABSTRACT

A semiconductor integrated circuit device includes: a serial signal input terminal that receives input of a command; a control signal input terminal that receives input of a control signal; and a circuit block that determines whether or not the circuit block has been selected using an identification code included in the command in the case where the control signal is activated, and if it is determined that the circuit block has been selected using the identification code, the circuit block performs an operation designated by the command.

### BACKGROUND

1. Technical Field

The present invention relates to a semiconductor integrated circuit device (IC) in which a serial interface circuit that serially inputs data is included, and furthermore relates to an electronic apparatus or the like using such a semiconductor integrated circuit device.

2. Related Art

A serial interface circuit is used in order to input data into a semiconductor integrated circuit device using few input terminals when testing a device such as a memory embedded in a semiconductor integrated circuit device or writing data in a non-volatile memory embedded in a semiconductor integrated circuit device, for example.

With previous techniques, a serial interface control circuit connected to the input terminal of a semiconductor integrated circuit device selected a macro (a circuit block having a specific function) embedded in the semiconductor integrated circuit device and controlled communication between an external device and the macro, based on serial signals supplied from the external device.

In this case, the serial interface control circuit needs to always keep track of the communication status in order to suitably control the serial interface operation. For this purpose, when the semiconductor integrated circuit device is designed, it has been necessary to define the specifications for serial communication between the external device and the macro in advance and design a serial interface control circuit based thereon. However, in the case where control that is unique for each macro is to be performed, there has been a problem in that the serial interface control circuit is complex and difficult to design, and as a result, the amount of time for serial communication also increases.

As a related technique, JP-A-2001-101900 (claim 1, FIG. 5) discloses efficient and accurate testing of multiple DRAM macro cells or the like mounted on a logic integrated circuit with embedded memory or the like. This semiconductor integrated circuit device includes multiple macro cells that each include a test circuit that can recognize an identification number given to a corresponding macro cell and selectively carry out a function test on the corresponding macro cell due to the identification number being designated.

However, the invention disclosed in JP-A-2001-101900 (claim 1, FIG. 5) presupposes a plurality of identical macro cells that perform communication based on common interface specifications. Accordingly, if a macro cell is different, its logic portion (serial interface control circuit) needs to be re-designed. Also, no consideration has been given to the case of performing different control in each of the multiple macro cells.

Also, JP-A-8-254570 (claim 1, FIG. 1) discloses a semiconductor integrated circuit that can observe embedded macro cells easily, reliably, and in a short amount of time. This semiconductor integrated circuit includes multiple macro cells, and an input/output portion that performs input of test data composed of a predetermined number of bits from an external terminal, and outputs output data read out from a macro cell to the external terminal. A test dedicated circuit (e.g., a shift register) that supplies the test data input from the input/output portion to a macro cell and transfers the output data output from the macro cell to the input/output portion is included in each macro cell.

However, with the semiconductor integrated circuit disclosed in JP-A-8-254570 (claim 1, FIG. 1), the input terminals or output terminals of the multiple macro cells are connected serially, and each time communication is performed with an external device, data passes through all of the input terminals or output terminals. Accordingly, the interconnect pattern is long. Also, since the data needs to be supplied to a macro cell that is a communication target with reference given to the state of the macro cells that are not communication targets, macro cell control is complicated.

### SUMMARY

In view of this, in light of the foregoing points, a first advantage of some aspects of the invention lies in making it possible to efficiently perform a serial interface operation with an external device, without requiring complicated control for individual circuit blocks included in a semiconductor integrated circuit device. Also, a second advantage of some aspects of the invention lies in providing an electronic apparatus or the like in which such a semiconductor integrated circuit device is used.

A semiconductor integrated circuit device according to one aspect of the invention includes: a serial signal input terminal configured to receive input of a command; a control signal input terminal configured to receive input of a control signal; and a circuit block configured to, if the control signal is activated, determine whether or not the circuit block has been selected using an identification code included in the command, and if it is determined that the circuit block has been selected using the identification code, perform an operation designated by the command.

A semiconductor integrated circuit device according to another aspect of the invention includes: a circuit block configured to activate a busy signal when an enable signal is activated, determine whether or not the circuit block has been selected using an identification code included in a command input to a serial signal input terminal when the enable signal is activated, and if it is determined that the circuit block has been selected using the identification code, maintain the activation of the busy signal for at least a period during which a series of serial signals are input thereto and perform the operation designated by the command; and a control circuit configured to activate the enable signal when the control signal is activated, and deactivate the enable signal when the busy signal is deactivated.

Furthermore, a semiconductor integrated circuit device according to another aspect of the invention includes: a circuit block configured to determine whether or not the circuit block has been selected using an identification code included in a command input to a serial signal input terminal when an enable signal is activated, and if it is determined that the circuit block has been selected using the identification code, activate the busy signal for at least a period during which a series of serial signals are input thereto and perform the operation designated by the command; and a control circuit configured to activate the enable signal when the control signal is activated, and deactivate the enable signal when the busy signal is deactivated.

According to an aspect of the invention, the serial interface operation need only be controlled in accordance with the busy signal output from the circuit block, and therefore there is no need to adjust the specifications for serial communication for the entire semiconductor integrated circuit device. Accordingly, it is possible to efficiently perform the serial interface operation with an external device without requiring complicated control for individual circuit blocks. Also, optimal serial communication specifications can be set individually for each circuit block, and therefore unique control is also made possible. Furthermore, since the length of the serial signals can be set to the minimum necessary limit, it is possible to shorten the amount of time for serial communication.

If it is determined that the circuit block has been selected using the identification code, the circuit block may deactivate the busy signal upon elapse of a period during which a series of serial signals are input thereto. In this case, the external circuit performing communication with the semiconductor integrated circuit device can confirm that the circuit block has received the series of serial signals and can rapidly transition to control of the logic circuit and other circuit blocks.

Alternatively, if it is determined that the circuit block has been selected using the identification code, the circuit block may deactivate the busy signal after the operation designated by the command ends. In this case, the external circuit performing communication with the semiconductor integrated circuit device can confirm that the circuit block has ended the operation and cause the circuit block to perform the next operation.

Alternatively, if it is determined that the circuit block has been selected using the identification code, when the enable signal is activated, the circuit block may determine whether or not the circuit block has been selected using a second identification code included in a second command input to the serial signal input terminal, and if it is determined that the circuit block has not been selected using the identification code, the circuit block may deactivate the busy signal. In this case, the external circuit performing communication with the semiconductor integrated circuit device can repeatedly transmit addresses and data to the same circuit block.

The semiconductor integrated circuit device may include a plurality of circuit blocks each configured to determine whether or not the circuit block has been selected using an identification code when an enable signal is activated, and if it is determined that the circuit block has been selected using the identification code, activate a busy signal for at least a period during which a series of serial signals are input thereto, and perform an operation designated by a command, and when one of the plurality of circuit blocks activates a busy signal, the control circuit may deactivate the enable signals supplied to the other circuit blocks. In this case, the operation of a circuit block that has not been selected can be stopped.

Furthermore, it is possible to use a configuration in which the activation of the control signal is not detected in a normal operation mode. In this case, in a normal operation mode, it is possible to prevent the semiconductor integrated circuit device from erroneously transitioning to the test mode in which a circuit block is tested.

For example, the semiconductor integrated circuit device may further include a control signal generation circuit configured to activate the control signal when a difference between a voltage applied to a signal input terminal and a high-potential-side power supply voltage is greater than a predetermined value, or when a difference between a low-potential-side power supply voltage and a voltage applied to a signal input terminal is greater than a predetermined value. In this case, even without newly providing a control signal input terminal, it is possible to cause the semiconductor integrated circuit device to transition to the test mode by merely controlling the voltage applied to the signal input terminal that is already present.

Alternatively, the semiconductor integrated circuit device may further include a control signal generation circuit configured to activate the control signal when an applied power supply voltage is greater than a predetermined value. In this case, even without newly providing a control signal input terminal, it is possible to cause the semiconductor integrated circuit device to transition to the test mode by merely controlling the power supply voltage.

Furthermore, an electronic apparatus according to one aspect of the invention includes any of the above-described semiconductor integrated circuit devices. Accordingly, it is possible to provide an electronic apparatus according to which it is easier to control the serial interface operation of a circuit block embedded in the semiconductor integrated circuit device.

Furthermore, a method for controlling a circuit according to one aspect of the invention includes: determining, in a case where an input control signal is activated, whether or not the circuit has been selected using an identification code included in an input command; and performing an operation designated by the command in a case where it is determined that the circuit has been selected using the identification code.

### BRIEF DESCRIPTION OF THE DRAWINGS

The invention will be described with reference to the accompanying drawings, wherein like numbers reference like elements.

FIG. 1 is a diagram showing a configuration example of a portion of a semiconductor integrated circuit device according to a first embodiment of the invention.

FIG. 2 is a timing chart showing an operation example of the semiconductor integrated circuit device shown in FIG. 1.

FIG. 3 is a circuit diagram showing a configuration example of a serial I/F circuit according to a second embodiment of the invention.

FIG. 4 is a timing chart showing an operation example of the serial I/F circuit shown in FIG. 3.

FIG. 5 is a circuit diagram showing a configuration example of a semiconductor integrated circuit device according to a third embodiment of the invention.

FIG. 6 is a timing chart showing a first operation example of the semiconductor integrated circuit device shown in FIG. 5.

FIG. 7 is a flowchart showing the first operation example of the semiconductor integrated circuit device shown in FIG. 5.

FIG. 8 is a diagram showing a relationship between serial signals and operation contents in the first operation example.

FIG. 9 is a timing chart showing a second operation example of the semiconductor integrated circuit device shown in FIG. 5.

FIG. 10 is a flowchart showing a second operation example of the semiconductor integrated circuit device shown in FIG. 5.

FIG. 11 is a diagram showing a relationship between serial signals and operation contents in the second operation example.

FIG. 12 is a circuit diagram showing a first example of a control signal generation circuit.

FIG. 13 is a diagram for illustrating an operation of the control signal generation circuit shown in FIG. 12.

FIG. 14 is a circuit diagram showing a second example of a control signal generation circuit.

FIG. 15 is a diagram for illustrating an operation of the control signal generation circuit shown in FIG. 14.

FIG. 16 is a circuit diagram showing a third example of a control signal generation circuit.

FIG. 17 is a diagram for illustrating an operation of the control signal generation circuit shown in FIG. 16.

FIG. 18 is a block diagram showing a configuration example of an electronic apparatus according to an embodiment of the invention.

### DESCRIPTION OF EXEMPLARY EMBODIMENTS

Hereinafter, embodiments of the invention will be described in detail with reference to the drawings. Note that identical constituent elements are denoted by identical reference signs, and descriptions thereof will not be repeated.

### First Embodiment

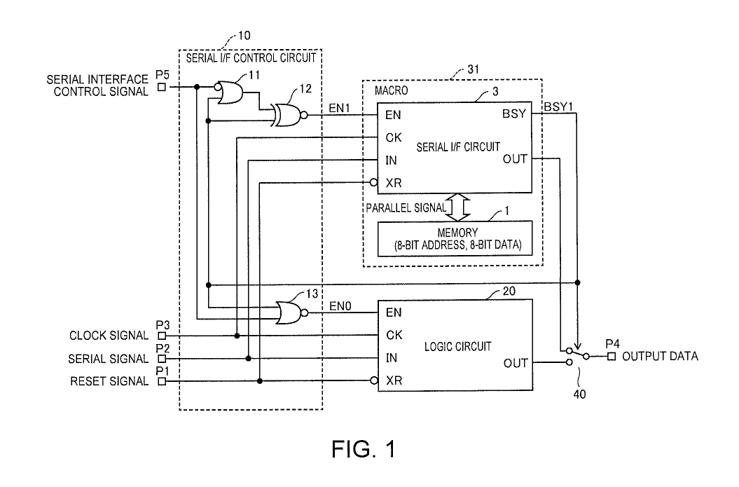

FIG. 1 is a diagram showing a configuration example of a portion of a semiconductor integrated circuit device according to a first embodiment of the invention. As shown in FIG. 1, the semiconductor integrated circuit device includes a serial I/F (interface) control circuit (referred to hereinafter simply as “control circuit”) 10, a logic circuit 20, a macro 31, which is a circuit block having a specific function, and a selector circuit 40. Moreover, the semiconductor integrated circuit device includes a reset signal input terminal (pad) P1, a serial signal input terminal P2, a clock signal input terminal P3, and a data output terminal P4, and may further include a control signal input terminal P5.

For example, the control circuit 10 includes an OR circuit 11 with one inverting input, an ENOR circuit 12, and a NOR circuit 13. In accordance with a serial interface control signal (hereinafter referred to simply as “control signal”), the control circuit 10 individually controls the serial interface operation between an internal circuit of the semiconductor integrated circuit device and an external circuit such as an IC tester. The control signal is supplied from the external circuit to the control circuit input terminal P5, or is generated in the semiconductor integrated circuit device.

For example, the logic circuit 20 is constituted by a combinational circuit or a sequential circuit, carries out logic operations on the input serial signals (serial data), and outputs the thus-obtained data. Moreover, the macro 31 includes a serial I/F (interface) circuit 3, and a functional device such as a memory 1. Hereinafter, a case in which the functional device is a non-volatile memory will be described as an example. Parallel signals are transferred between the serial I/F circuit 3 and the memory 1.

The serial signal input terminal P2 receives input of serial data to be supplied to the logic circuit 20 or serial signals to be supplied to the macro 31. In this example, the serial signals to be supplied to the macro 31 include an 8-bit command including an identification code, an 8-bit address, and 8-bit data.

The logic circuit 20 and the macro 31 are reset while the reset signal input from the external circuit to the reset signal input terminal P1 is activated to the low level. At this time, the serial I/F circuit 3 of the macro 31 deactivates the busy signal BSY1 to the low level. When the reset signal is deactivated to the high level, the reset of the logic circuit 20 and the macro 31 is released.

When the control signal and the busy signal BSY1 are deactivated to the low level, the control circuit 10 activates an enable signal EN0 to be supplied to the logic circuit 20 to the high level and deactivates an enable signal EN1 to be supplied to the macro 31 to the low level. Accordingly, the semiconductor integrated circuit device is set to the normal operation mode.

For example, in the control circuit 10, the low-level busy signal BSY1 is input to the first input terminal of the NOR circuit 13 and the low-level control signal is input to the second input terminal of the NOR circuit 13, and thereby the NOR circuit 13 outputs the high-level enable signal EN0. Also, the low-level control signal is input to the inverting input terminal of the OR circuit 11, and the OR circuit 11 outputs a high-level signal. Because the busy signal BSY1 is at the low level, the ENOR circuit 12 outputs the low-level enable signal EN1.

In this state, the macro 31 stops operation, while the logic circuit 20 operates in accordance with the serial data and the clock signal input respectively to the serial signal input terminal P2 and the clock signal input terminal P3 from the external circuit. Because the busy signal BSY1 is deactivated, the selector circuit 40 supplies the data output from the logic circuit 20 to the data output terminal P4.

When the control signal is activated to the high level, the control circuit 10 deactivates the enable signal EN0 to be supplied to the logic circuit 20 to the low level and activates the enable signal EN1 to be supplied to the macro 31 to the high level. Accordingly, the semiconductor integrated circuit device transitions to the test mode.

For example, in the control circuit 10, the high-level control signal is input to the second input terminal of the NOR circuit 13, and as a result, the NOR circuit 13 outputs the low-level enable signal EN0. Also, the high-level control signal is input to the inverting input terminal of the OR circuit 11, and the low-level busy signal BSY1 is input to the non-inverting input terminal of the OR circuit 11, and as a result, the OR circuit 11 outputs a low-level signal. Accordingly, the ENOR circuit 12 outputs the high-level enable signal EN1.

In this state, the logic circuit 20 stops operation, while the macro 31 activates the busy signal BSY1 to the high level and transitions to the serial signal standby mode. Upon receiving input of the serial signals from the external circuit to the serial signal input terminal P2, when the enable signal EN1 is activated, the macro 31 determines whether or not the macro 31 has been selected using the identification code included in the command input to the serial signal input terminal P2.

If it is determined that the macro 31 has been selected using the identification code, the macro 31 maintains the activation of the busy signal BSY1 for at least the period during which the series of serial signals are input thereto, and performs the operation designated by the command. Accordingly, it is possible to test the memory 1 and to write data into the memory 1. Because the busy signal BSY1 is activated, the selector circuit 40 supplies the data output from the macro 31 to the data output terminal P4. On the other hand, if it is determined that the macro 31 has not been selected using the identification code, the busy signal BSY1 is deactivated to the low level and the operation is stopped.

For example, in the macro 31, the serial I/F circuit 3 activates the busy signal BSY1 when the enable signal EN1 is activated. Moreover, the identification code allocated to the macro 31 is stored in a portion of the storage region of the memory 1. The serial I/F circuit 3 determines whether or not the macro 31 has been selected using the identification code included in the command by comparing the identification code included in the command input from the external circuit to the serial signal input terminal P2 with the identification code stored in the memory 1. Accordingly, it is possible for the operation designated by the command to be performed by only the selected macro.

If it is determined that the macro 31 has been selected, the serial I/F circuit 3 causes the memory 1 to operate in accordance with the command, address, or data included in the series of serial signals input to the serial signal input terminal P2 and in accordance with the clock signal input to the clock signal input terminal P3.

For example, if the command is a write command, the serial I/F circuit 3 writes 8-bit data in the group of memory cells designated by the 8-bit address in the memory 1. Alternatively, if the command is a read command, the serial I/F circuit 3 reads out 8-bit data from the group of memory cells designated by the 8-bit address in the memory 1.

Even if the control signal is deactivated to the low level after the busy signal BSY1 is activated, the control circuit 10 continues the activation of the enable signal EN1 in the period during which the busy signal BSY1 is activated. For example, in the control circuit 10, the high-level busy signal BSY1 is input to the first input terminal of the NOR circuit 13, and as a result, the NOR circuit 13 outputs the low-level enable signal EN0. Also, the high-level busy signal BSY1 is input to the non-inverting input terminal of the OR circuit 11, and as a result, the OR circuit 11 outputs a high-level signal. Accordingly, the ENOR circuit 12 outputs the high-level enable signal EN1.

If it is determined that the macro 31 has been selected, the serial I/F circuit 3 may deactivate the busy signal BSY1 upon the elapse of a period during which the series of serial signals are input. In this case, the external circuit can confirm that the macro 31 has received the series of serial signals and can rapidly transition to control of the logic circuit 20 or another macro. Alternatively, the serial I/F circuit 3 may deactivate the busy signal BSY1 after the operation designated by the command ends. In this case, the external circuit can confirm that the macro 31 has ended the operation and cause the macro 31 to perform the next operation.

Alternatively, when the enable signal EN1 is activated, the serial I/F circuit 3 determines whether or not the macro 31 has been selected using the second identification code included in the second command input from the external circuit to the serial signal input terminal P2, and if it is determined that the macro 31 has not been selected using the second identification code, the serial I/F circuit 3 may deactivate the busy signal BSY1. At this time, the external circuit can repeatedly transmit addresses and data to the same macro.

When the busy signal BSY1 is deactivated, the control circuit 10 activates the enable signal EN0 to be supplied to the logic circuit 20 to the high level and deactivates the enable signal EN1 to be supplied to the macro 31 to the low level. Accordingly, the semiconductor integrated circuit device returns to the normal operation mode.

For example, in the control circuit 10, the low-level busy signal BSY1 is input to the first input terminal of the NOR circuit 13 and the low-level control signal is input to the second input terminal of the NOR circuit 13, and as a result, the NOR circuit 13 outputs the high-level enable signal EN0. Also, the low-level control signal is input to the inverting input terminal of the OR circuit 11, and as a result, the OR circuit 11 outputs a high-level signal. Because the busy signal BSY1 is at the low level, the ENOR circuit 12 outputs a low-level enable signal EN1.

Operation Example of First Embodiment

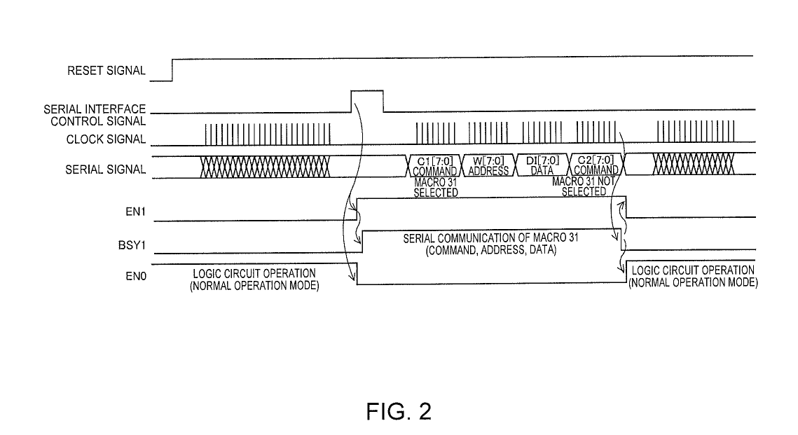

FIG. 2 is a timing chart showing an operation example of the semiconductor integrated circuit device shown in FIG. 1. As shown in FIG. 2, immediately after power is supplied, the reset signal is activated to the low level, the enable signal EN0 to be supplied to the logic circuit 20 is activated to the high level, and the enable signal EN1 to be supplied to the macro 31 is deactivated to the low level. When the reset is released, the logic circuit 20 operates in accordance with serial data input from the external circuit and a clock signal (normal operation mode).

Thereafter, when the control signal is activated to the high level, the control circuit 10 deactivates the enable signal EN0 to be supplied to the logic circuit 20 to the low level and activates the enable signal EN1 to be supplied to the macro 31 to the high level. Accordingly, the serial I/F circuit 3 of the macro 31 activates the busy signal BSY1 to the high level. After the busy signal BSY1 is activated, the control signal is deactivated.

If it is determined that the macro 31 has been selected using the identification code included in the command C1[7:0] input from the external circuit, the serial I/F circuit 3 causes the memory 1 to operate in accordance with the command C1[7:0], the address W[7:0], or the data DI[7:0], and in accordance with the clock signal.

For example, if the command C1[7:0] is a write command, the serial I/F circuit 3 writes the data DI[7:0] in the group of memory cells designated by the address W[7:0] in the memory 1. Alternatively, if the command C1[7:0] is a read command, the serial I/F circuit 3 reads out 8-bit data from the group of memory cells designated by the address W [7:0] in the memory 1.

When the enable signal EN1 is activated, the serial I/F circuit 3 determines whether or not the macro 31 has been selected using the second identification code included in the second command C2[7:0] input from the external circuit, and if it is determined that the macro 31 has not been selected, the serial I/F circuit 3 deactivates the busy signal BSY1.

When the busy signal BSY1 is deactivated, the control circuit 10 activates the enable signal EN0 to be supplied to the logic circuit 20 to the high level and deactivates the enable signal EN1 to be supplied to the macro 31 to the low level. Accordingly, the logic circuit 20 operates in accordance with serial data input from the external circuit and a clock signal (normal operation mode).

According to the present embodiment, it is sufficient that the serial interface operation is controlled based on the busy signal BSY1 output from the macro 31, and therefore there is no longer a need to adjust the specifications for serial communication for the entire semiconductor integrated circuit device. Accordingly, it is possible to efficiently perform the serial interface operation with an external device without requiring complicated control for individual macros. Also, optimal serial communication specifications can be set individually for each macro, and therefore unique control is also made possible. Furthermore, since the length of the serial signal can be set to the minimum necessary limit, it is possible to shorten the amount of time for serial communication.

### Second Embodiment

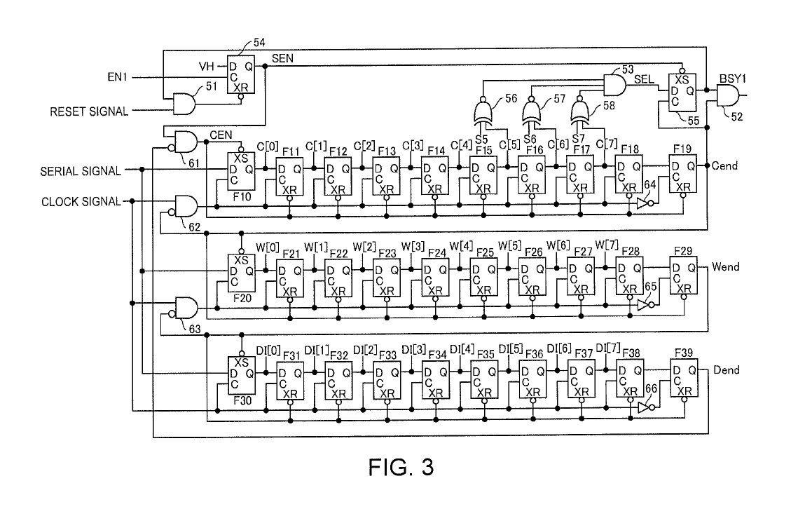

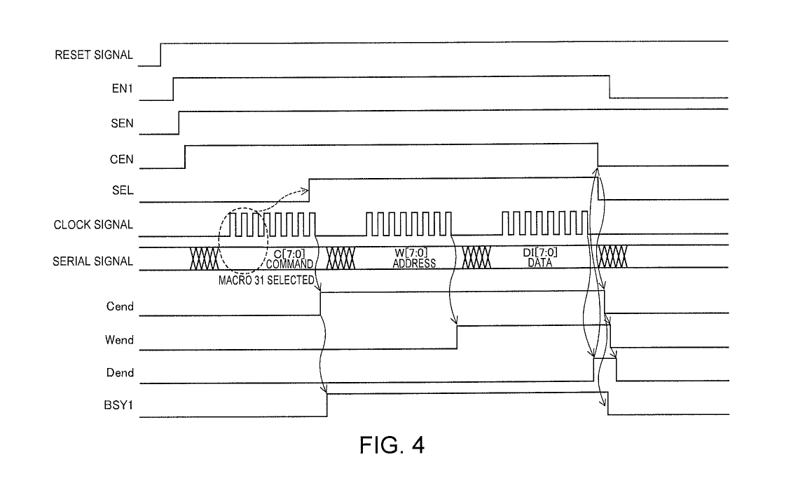

FIG. 3 is a circuit diagram showing a configuration example of a portion of a serial I/F circuit in a semiconductor integrated circuit device according to a second embodiment of the invention. Also, FIG. 4 is a timing chart showing an operation example of the serial I/F circuit shown in FIG. 3.

In the second embodiment, the macro 31 (FIG. 1) does not activate the busy signal BSY1 in response to the activation of the enable signal EN1, and if it is determined that the macro 31 has been selected using the identification code included in the command input to the serial signal input terminal P2, the busy signal BSY1 is activated for at least the period during which the series of serial signals are input. The second embodiment is similar to the first embodiment with regard to aspects other than this.

The serial I/F circuit 3a shown in FIG. 3 includes AND circuits 51 to 53, flip-flops 54 and S5, ENOR circuits 56 to 58, AND circuits 61 to 63 with one inverting input, and inverters 64 to 66. Furthermore, the serial I/F circuit 3a includes command-latch flip-flops F10 to F19, address-latch flip-flops F20 to F29, and data-latch flip-flops F30 to F39.

Reset State

The first input terminal of the AND circuit 51 receives input of the signal output by the flip-flop 55, and the second input terminal of the AND circuit 51 receives input of the reset signal. Accordingly, when the reset signal is activated to the low level, the AND circuit 51 outputs the low-level output signal to the inverting reset terminal XR of the flip-flop 54. Thus, the flip-flop 54 is reset, and the serial enable signal SEN is deactivated to the low level. The flip-flop 55 is set due to the low-level serial enable signals SEN being applied to the inverting set terminal XS, and outputs the high-level output signal.

The non-inverting input terminal of the AND circuit 61 receives input of the low-level serial enable signals SEN and the inverting input terminal of the AND circuit 61 receives input of the data end signal Dend. Accordingly, the AND circuit 61 deactivates the command enable signal CEN to the low level. The low-level command enable signal CEN is applied to the inverting set terminal XS of the flip-flop F10 and the inverting reset terminals XR of the flip-flops F11 to F19. Thus, the flip-flop F10 is set, and the high-level signal (initial value of command) is output. Also, the flip-flops F11 to F19 are reset, whereby the command end signal Cend is deactivated to the low level. Accordingly, the busy signal BSY1 is also deactivated to the low level.

The low-level command end signal Cend is applied to the inverting set terminal XS of the flip-flop F20 and the inverting reset terminals XR of the flip-flops F21 to F29. Thus, the flip-flop F20 is set so as to output a high-level signal (initial value of address). Also, the flip-flops F21 to F29 are reset so as to deactivate the address end signal Wend to the low level.

The low-level address end signal Wend is applied to the inverting set terminal XS of the flip-flop F30 and the inverting reset terminals XR of the flip-flops F31 to F39. Thus, the flip-flop F30 is set so as to output the high-level signal (initial value of data). Also, the flip-flops F31 to F39 are reset so that the data end signal Dend is deactivated to the low level.

The non-inverting input terminal of the AND circuit 62 receives input of a clock signal, and the non-inverting input terminal of the AND circuit 62 receives input of the low-level command end signal Cend. Accordingly, the AND circuit 62 outputs the clock signal. The non-inverting input terminal of the AND circuit 63 receives input of the clock signal, and the inverting input terminal of the AND circuit 63 receives input of the low-level address end signal Wend. Accordingly, the AND circuit 63 outputs the clock signal.

Command Latch

When the reset signal is deactivated to the high level, the output signal of the AND circuit 51 reaches the high level, and therefore the reset of the flip-flop 54 is released. A voltage VH at a high level is input to the data input terminal D, and therefore when the enable signal EN1 is activated to the high level, the flip-flop 54 activates the serial enable signal SEN to the high level. Thus, the setting of the flip-flop 55 is released, and the AND circuit 61 activates the command enable signal CEN to the high level.

Accordingly, the setting of the flip-flop F10 is released, and the reset of the flip-flops F11 to F19 is released. The flip-flops F10 to F18 sequentially latch the command C[7:0] at the rising edge of the clock signal. At the rising edge of the eighth pulse of the clock signal after the command enable signal CEN is activated to the high level, the flip-flops F10 to F17 respectively latch the commands C[0] to C[7] and the flip-flop F18 latches the high-level signal (initial value of command). At the falling edge of the eighth pulse of the clock signal after the command enable signal CEN is activated to the high level, the flip-flop F19 activates the command end signal Cend to the high level. Accordingly, the output signal of the AND circuit 62 reaches the low level.

Here, the commands C[5] to C[7] correspond to the identification code for selecting the macro. Also, the identification codes S5 to S7 applied to the macro 31 are stored in the memory 1 (FIG. 1). The ENOR circuits 56 to 58 respectively compare the commands C[5] to C[7] with the identification codes S5 to S7, and if both match, the signal indicating the comparison result is set to the high level, and if both do not match, the signal indicating the comparison result is set to the low level. When all of the signals indicating the comparison results are at the high level, the AND circuit 53 activates the selection signal SEL to the high level. The flip-flop 55 latches the selection signal SEL when the command end signal Cend is activated to the high level.

The first input terminal of the AND circuit 52 receives input of the selection signal SEL latched in the flip-flop 55, and the second input terminal of the AND circuit 52 receives input of the command end signal Cend. Accordingly, when the selection signal SEL latched in the flip-flop 55 and the command end signal Cend are activated to the high level, the AND circuit 52 activates the busy signal BSY1 to the high level. Note that if the selection signal SEL latched in the flip-flop 55 is at the low level, the busy signal BSY1 is not activated.

Address Latch

Due to the command end signal Cend being activated to the high level, the setting of the flip-flop F20 is released, and the reset of the flip-flops F21 to F29 is released. The flip-flops F20 to F28 sequentially latch the address W[7:0] at the rising edge of the clock signal.

At the rising edge of the eighth pulse of the clock signal after the command end signal Cend is activated to the high level, the flip-flops F20 to F27 respectively latch the addresses W[0] to W[7] and the flip-flop F28 latches the high-level signal (initial value of address). At the falling edge of the eighth pulse of the clock signal after the command end signal Cend is activated to the high level, the flip-flop F29 activates the address end signal Wend to the high level. Accordingly, the output signal of the AND circuit 63 reaches the low level.

Data Latch

Due to the address end signal Wend being activated to the high level, the setting of the flip-flop F30 is released, and the reset of the flip-flops F31 to F39 is released. The flip-flops F30 to F38 sequentially latch the data DI [7:0] at the rising edge of the clock signal.

At the rising edge of the eighth pulse of the clock signal after the address end signal Wend is deactivated to the high level, the flip-flops F30 to F37 respectively latch the data DI[0] to DI[7] and the flip-flop F38 latches the high-level signal (initial value of data). At the falling edge of the eighth pulse of the clock signal after the address end signal Wend is deactivated to the high level, the flip-flop F39 activates the data end signal Dend to the high level. Accordingly, the AND circuit 61 deactivates the command enable signal CEN to the low level.

Also, the serial I/F circuit 3a causes the memory 1 (FIG. 1) to operate. For example, the serial I/F circuit 3a writes the data DI[7:0] in the group of memory cells designated by the address W[7:0] in the memory 1. Furthermore, the flip-flop F19 is reset so as to deactivate the command end signal Cend to the low level. Accordingly, the busy signal BSY1, the address end signal Wend, and the data end signal Dend are also deactivated to the low level. Also, due to the busy signal BSY1 being deactivated, the control circuit 10 (FIG. 1) deactivates the enable signal EN1 to the low level.

In the second embodiment as well, it is possible to achieve an effect similar to that achieved in the first embodiment. Also, with the second embodiment, even if the semiconductor integrated circuit device includes multiple macros, multiple busy signals are not activated at the same time, and therefore it is easier to specify the operating macro.

### Third Embodiment

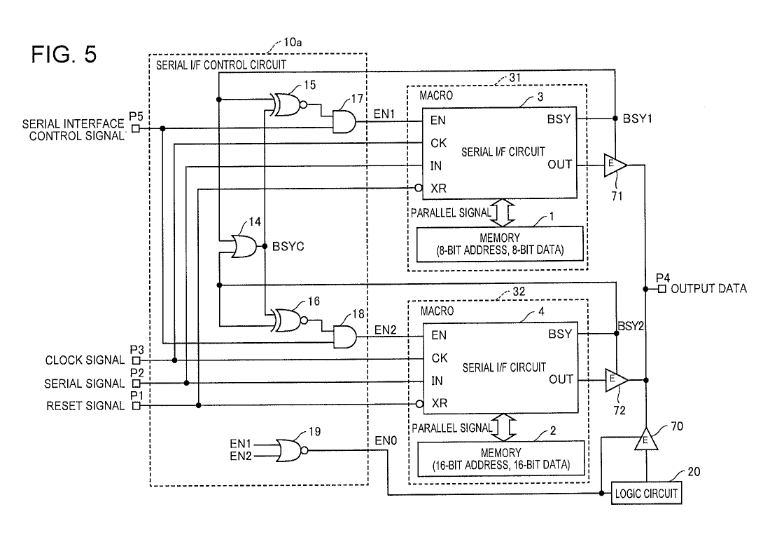

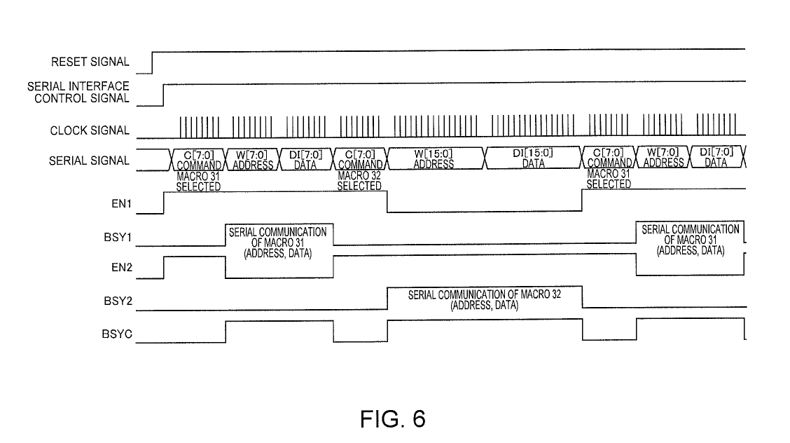

FIG. 5 is a circuit diagram showing a configuration example of a portion of a semiconductor integrated circuit device according to a third embodiment of the invention. Also, FIG. 6 is a timing chart showing a first operation example of the semiconductor integrated circuit device shown in FIG. 5.

In the third embodiment, the semiconductor integrated circuit device includes a serial I/F control circuit (hereinafter referred to as simply a “control circuit”) 10a, multiple macros (macros 31 and 32 are shown in FIG. 5 as examples), and buffer circuits 71 and 72, and may furthermore include a logic circuit 20 and a buffer circuit 70. The third embodiment is similar to the first embodiment or the second embodiment in aspects other than this.

For example, the control circuit 10a includes an OR circuit 14, ENOR circuits 15 and 16, AND circuits 17 and 18, and a NOR circuit 19. In accordance with a serial interface control signal (hereinafter referred to simply as “control signal”), the control circuit 10a individually controls the serial interface operation between an internal circuit of the semiconductor integrated circuit device and an external circuit such as an IC tester.

Moreover, the macro 32 includes a serial I/F (interface) circuit 4 and a device such as a memory 2. Parallel signals are transferred between the serial I/F circuit 4 and the memory 2. The serial signal input terminal P2 receives input of serial signals (serial data) to be supplied to the logic circuit 20 or serial signals to be supplied to the macro 31 or 32.

The macros 31 and 32 perform a serial interface operation based on respective serial communication specifications. For example, the macro 31 operates by receiving a supply of serial signals including an 8-bit command including an identification code, an 8-bit address, and 8-bit data. On the other hand, the macro 32 operates by receiving a supply of serial signals including an 8-bit command including an identification code, a 16-bit address, and 16-bit data.

Each of the buffer circuits 70 to 72 has an enable terminal E, and when the signal applied to the enable terminal E is activated to the high level, the signal input to the input terminal is buffered and output from an output terminal. Also, when the signal applied to the enable terminal E is deactivated to the low level, each of the buffer circuits 70 to 72 sets the output terminal to a high-impedance state.

The macro 31 and the macro 32 are reset while the reset signal supplied from the external circuit to the reset signal input terminal P1 is activated to the low level. At this time, the serial I/F circuits 3 and 4 deactivate the busy signals BSY1 and BSY2 respectively to the low level. When the reset signal is deactivated to the high level, the reset of the macros 31 and 32 is released.

When the control signal and all of the busy signals BSY1 to BSY2 are deactivated to the low level, the control circuit 10a activates the enable signal EN0 to be supplied to the logic circuit 20 to the high level, and deactivates the enable signals EN1 and EN2 to be respectively supplied to the macros 31 and 32 to the low level. Accordingly, the semiconductor integrated circuit device is set to the normal operation mode.

For example, in the control circuit 10a, the low-level control signal is input to the second input terminal of the AND circuits 17 and 18, and the AND circuits 17 and 18 respectively output the low-level enable signals EN1 and EN2. Also, the low-level enable signals EN1 and EN2 are respectively input to the two input terminals of the NOR circuit 19, and thereby the NOR circuit 19 outputs the high-level enable signal EN0.

In this state, the macros 31 and 32 stop operation, while the logic circuit 20 operates in accordance with the serial data and the clock signal input respectively to the serial signal input terminal P2 and the clock signal input terminal P3 from the external circuit. Because the enable signal EN0 is activated, the buffer circuit 70 supplies the data output from the logic circuit 20 to the data output terminal P4.

When the control signal is activated to the high level, the control circuit 10a activates the enable signals EN1 and EN2 to be respectively supplied to the macros 31 and 32 to the high level and deactivates the enable signal EN0 to be supplied to the logic circuit 20 to the low level. Accordingly, the semiconductor integrated circuit device transitions to the test mode.

For example, in the normal operation mode, the output signals of the ENOR circuits 15 and 16 of the control circuit 10a are at the high level. Accordingly, when the control signal is activated to the high level, the AND circuits 17 and 18 respectively output the high-level enable signals EN1 and EN2. Also, the high-level enable signals EN1 and EN2 are respectively input to the two input terminals of the NOR circuit 19, and as a result, the NOR circuit 19 outputs the low-level enable signal EN0.

In this state, the logic circuit 20 stops operation, while the macros 31 and 32 transition to the serial signal standby mode. When the enable signal EN1 is active, the macro 31 determines whether or not the macro 31 has been selected using the identification code included in the command input from the external circuit to the serial signal input terminal P2.

If it is determined that the macro 31 has been selected using the identification code, the macro 31 activates the busy signal BSY1 to the high level for the period during which at least the series of serial signals are input, and performs the operation designated by the command. On the other hand, if it is determined that the macro 31 has not been selected using the identification code, the busy signal BSY1 is deactivated and the operation is stopped.

For example, the serial I/F circuit 3 determines whether or not the macro 31 has been selected using the identification code included in the command by comparing the identification code included in the command input from the external circuit to the serial signal input terminal P2 and the identification code stored in the memory 1 in the macro 31.

If it is determined that the macro 31 has been selected, the serial I/F circuit 3 activates the busy signal BSY1. Accordingly, the buffer circuit 71 supplies the data output from the macro 31 to the data output terminal P4. Also, the serial I/F circuit 3 causes the memory 1 to operate in accordance with the commands, addresses, or data included in the series of serial signals input to the serial signal input terminal P2 and the clock signal input to the clock signal input terminal P3.

For example, if the command C[7:0] is a write command, the serial I/F circuit 3 writes the data DI[7:0] in the group of memory cells designated by the address W[7:0] in the memory 1. Alternatively, if the command C[7:0] is a read command, the serial I/F circuit 3 reads out 8-bit data from the group of memory cells designated by the address W[7:0] in the memory 1.

Similarly, when the enable signal EN2 is activated, the macro 32 also determines whether or not the macro 32 has been selected using the identification code included in the command input from the external circuit to the serial signal input terminal P2. If it is determined that the macro 32 has been selected using the identification code, the macro 32 activates the busy signal BSY2 to the high level for at least the period during which the series of serial signals are input, and performs the operation designated by the command. Accordingly, it is possible to test the memory 2 and to write data in the memory 2, which is a non-volatile memory. On the other hand, if it is determined that the macro 32 has not been selected using the identification code, the busy signal BSY2 is deactivated and the operation is stopped.

For example, the serial I/F circuit 4 determines whether or not the macro 32 has been selected using the identification code included in the command by comparing the identification code included in the command input from the external circuit to the serial signal input terminal P2 and the identification code stored in the memory 2 in the macro 32.

If it is determined that the macro 32 has been selected, the serial I/F circuit 4 activates the busy signal BSY2. Accordingly, the buffer circuit 72 supplies the data output from the macro 32 to the data output terminal P4. Also, the serial I/F circuit 4 causes the memory 2 to operate in accordance with the command, address, or data included in the series of serial signals input to the serial signal input terminal P2, and in accordance with the clock signal input to the clock signal input terminal P3.

For example, if the command is a write command, the serial I/F circuit 4 writes 16-bit data in the group of memory cells designated by the 16-bit address in the memory 2. Alternatively, if the command is a read command, the serial I/F circuit 4 reads out 16-bit data from the group of memory cells designated by the 16-bit address in the memory 2.

The serial I/F circuit 3 or 4 may deactivate the busy signal BSY1 or BSY2 upon the elapse of a period during which the series of serial signals are input, or the serial I/F circuit 3 or 4 may deactivate the busy signal BSY1 or BSY2 after the operation designated by the command ends.

When one of the multiple macros 31 and 32 activates a busy signal, the control circuit 10a deactivates the enable signal to be supplied to the other macro. For example, when the busy signal BSY1 output from the macro 31 is activated to the high level, the control circuit 10a deactivates the enable signal EN2 supplied to the macro 32.

In the control circuit 10a, the OR circuit 14 whose first input terminal receives supply of the high-level busy signal BSY1 activates a common busy signal BSYC to the high level. Accordingly, the ENOR circuit 15 outputs a high-level signal and the ENOR circuit 16 outputs a low-level signal. As a result, the AND circuit 17 maintains the activation of the enable signal EN1, and the AND circuit 18 deactivates the enable signal EN2 to the low level. Accordingly, the operation of the macro 32, which was not selected, can be stopped.

Also, when the busy signal output from one of the multiple macros 31 and 32 is deactivated, the control circuit 10a reactivates the enable signal supplied to the other macro. For example, when the busy signal BSY1 output from the macro 31 is deactivated to the low level, the control circuit 10a reactivates the enable signal EN2 supplied to the macro 32. This makes it possible to determine whether or not the macro 32 has been selected using the identification code as well.

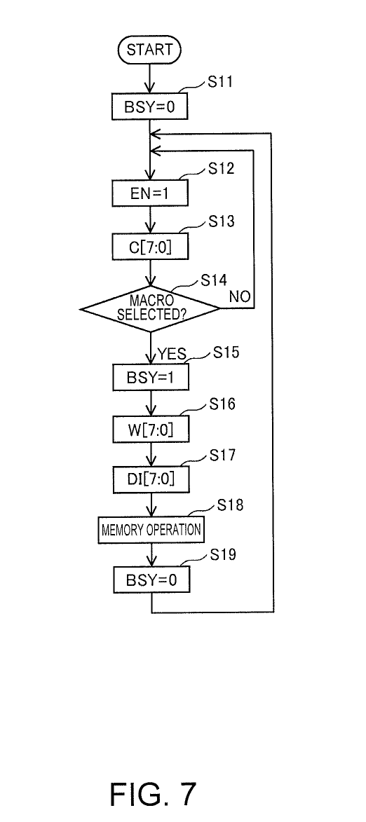

FIG. 7 is a flowchart showing a first operation example of the semiconductor integrated circuit device shown in FIG. 5. In step S11 in FIG. 7, when the power supply voltage is applied to the semiconductor integrated circuit device and the circuits in the semiconductor integrated circuit device are reset, all of the macros deactivate the busy signals BSY to the low level “0”. Thereafter, the control signal is activated.

In step S12, the control circuit 10a activates the enable signals EN supplied to all of the macros to the high level “1”. In step S13, all of the macros store the command C[7:0] input to the serial signal input terminal.

In step S14, all of the macros determine whether or not they have been selected using the identification code included in the command C[7:0]. In the macro selected using the identification code (e.g., macro 31), the processing transitions to step S15. In step S15, the macro 31 activates the busy signal BSY1 to the high level “1”.

Thus, the control circuit 10a deactivates the enable signal EN2 supplied to the macro that was not selected using the identification code (e.g., macro 32). The macro 32 stops operation until the enable signal EN2 is activated.

Furthermore, in step S16, the serial I/F circuit 3 of the macro 31 stores the address W[7:0] input to the serial signal input terminal, and thereafter, in step S17, the serial I/F circuit 3 stores the data DI[7:0] input to the serial signal input terminal.

In step S18, the serial I/F circuit 3 causes the memory 1 to operate. For example, the serial I/F circuit 3 writes the data DI[7:0] in the group of memory cells designated by the address W[7:0] in the memory 1. In step S19, the macro 31 deactivates the busy signal BSY1 to the low level “0”. Thereafter, the processing returns to step S12.

In step S12, the control circuit 10a activates the enable signals EN supplied to all of the macros to the high level “1”. In step S13, all of the macros store the command C[7:0] input to the serial signal input terminal.

In step S14, all of the macros determine whether or not they have been selected using the identification code included in the command C[7:0]. In the macro selected using the identification code (e.g., macro 32), the processing transitions to step S15. In step S15, the macro 32 activates the busy signal BSY2 to the high level “1”.

Thus, the control circuit 10a deactivates the enable signal EN1 to be supplied to the macro that was not selected using the identification code (e.g., macro 31). The macro 31 stops operation until the enable signal EN1 is activated.

Furthermore, in step S16, the serial I/F circuit 4 of the macro 32 stores the address input to the serial signal input terminal, and thereafter, in step S17, the serial I/F circuit 4 stores the data input to the serial signal input terminal.

In step S18, the serial I/F circuit 4 causes the memory 2 to operate. For example, the serial I/F circuit 4 writes the data in the group of memory cells designated by the address in the memory 2. In step S19, the macro 32 deactivates the busy signal BSY2 to the low level “0”. Thereafter, the processing returns to step S12.

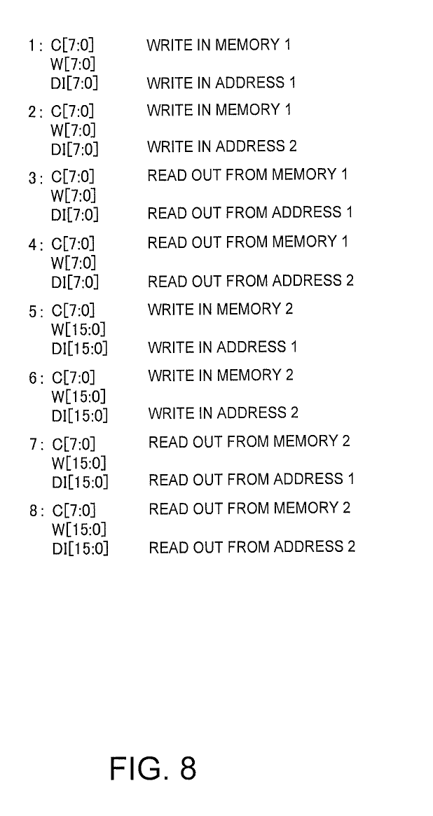

FIG. 8 is a diagram showing a relationship between serial signals and operation contents according to the first operation example of the semiconductor integrated circuit device shown in FIG. 5. The first serial signal input to the serial signal input terminal includes a command C[7:0] indicating writing in the memory 1 of the macro 31, an address W[7:0], and data DI[7:0]. When the first serial signal is stored in the macro 31, writing in an address 1 in the memory 1 is performed.

The second serial signal input to the serial signal input terminal includes a command C[7:0] indicating writing in the memory 1 of the macro 31, an address W[7:0], and data DI[7:0]. When the second serial signal is stored in the macro 31, writing in an address 2 in the memory 1 is performed.

The third serial signal input to the serial signal input terminal includes a command C[7:0] indicating reading out from the memory 1 of the macro 31, an address W[7:0], and data DI[7:0]. When the third serial signal is stored in the macro 31, reading out from the address 1 in the memory 1 is performed.

The fourth serial signal input to the serial signal input terminal includes a command C[7:0] indicating reading out from the memory 1 of the macro 31, an address W[7:0], and data DI[7:0]. When the fourth serial signal is stored in the macro 31, reading out from the address 2 in the memory 1 is performed.

The fifth serial signal input to the serial signal input terminal includes a command C[7:0] indicating writing in the memory 2 of the macro 32, an address W[15:0], and data DI[15:0]. When the fifth serial signal is stored in the macro 32, writing in the address 1 in the memory 2 is performed.

The sixth serial signal input to the serial signal input terminal includes a command C[7:0] indicating writing in the memory 2 of the macro 32, an address W[15:0], and data DI[15:0]. When the sixth serial signal is stored in the macro 32, writing in the address 2 in the memory 2 is performed.

The seventh serial signal input to the serial signal input terminal includes a command C[7:0] indicating reading out from the memory 2 of the macro 32, an address W[15:0], and data DI[15:0]. When the seventh serial signal is stored in the macro 32, reading out from the address 1 in the memory 2 is performed.

The eighth serial signal input to the serial signal input terminal includes a command C[7:0] indicating reading out from the memory 2 of the macro 32, an address W[15:0], and data DI[15:0]. When the eighth serial signal is stored in the macro 32, reading out from the address 2 in the memory 2 is performed.

According to the first operation example, even if the specifications for serial communication differs between the memory 1 and the memory 2, switching of the specifications for serial communication is automatically performed together with selection of the macro by controlling the operation of the memories 1 and 2 in accordance with the busy signal. Accordingly, the control circuit 10a does not need to always keep track of the state of communication with the macros, and need only wait for the deactivation of the busy signal.

Second Operation Example of Third Embodiment

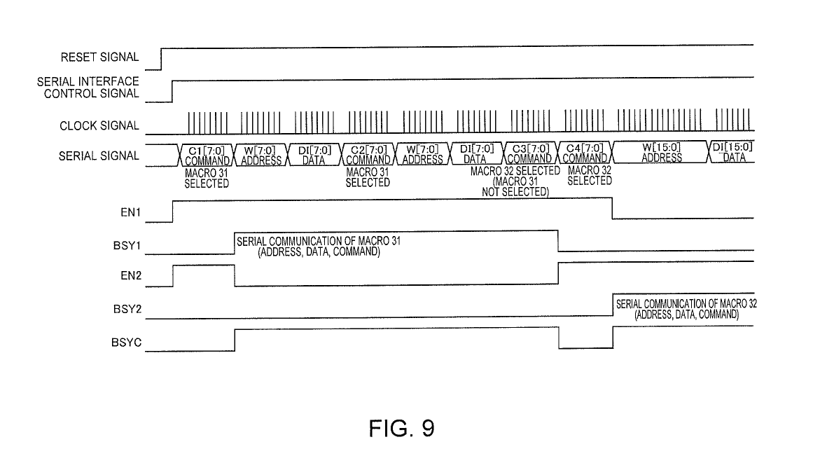

Also, FIG. 9 is a timing chart showing a second operation example of the semiconductor integrated circuit device shown in FIG. 5. In the second operation example, the macro does not deactivate the busy signal after input of the serial signals or after the end of the designated operation, but instead deactivates the busy signal if it is determined that the macro has not been selected using the identification code included in the subsequent command. With regard to aspects other than this, the second operation example is similar to the first operation example.

The macro 31 and the macro 32 are reset while the reset signal supplied from the external circuit to the reset signal input terminal P1 is activated to the low level. At this time, the serial I/F circuits 3 and 4 deactivate the busy signals BSY1 and BSY2 respectively to the low level. When the reset signal is deactivated to the high level, the reset of the macros 31 and 32 is released.

When the control signal is activated to the high level, the control circuit 10a activates the enable signals EN1 and EN2 to be supplied to the macros 31 and 32 to the high level. Accordingly, the semiconductor integrated circuit device transitions to the test mode.

In this state, the macros 31 and 32 transition to the serial signal standby mode. When the enable signal EN1 is activated, the macro 31 determines whether or not the macro 31 has been selected using the identification code included in the command input to the serial signal input terminal P2. If it is determined that the macro 31 has been selected using the identification code, the macro 31 activates the busy signal BSY1 to the high level and performs the operation designated by the command.

For example, in the macro 31, if the command C1[7:0] is a write command, the serial I/F circuit 3 writes the data D[7:0] in the group of memory cells designated by the address W[7:0] in the memory 1. Also, if the command C2[7:0] is a read command, the serial I/F circuit 3 reads out 8-bit data from the group of memory cells designated by the address W[7:0] in the memory 1.

Furthermore, the serial I/F circuit 3 determines whether or not the macro 31 has been selected using the identification code included in the command C3[7:0], and if it is determined that the macro 31 has not been selected, the busy signal BSY1 is deactivated. When the busy signal BSY1 output from the macro 31 is deactivated, the control circuit 10a activates the enable signal EN2 to be supplied to the macro 32. Thus, the macro 32 transitions to the serial signal standby mode.

When the enable signal EN2 is active, the macro 32 determines whether or not the macro 32 has been selected using the identification code included in the command input to the serial signal input terminal P2, and if it is determined that the macro 32 has been selected using the identification code, the macro 32 activates the busy signal BSY2 to the high level and performs the operation designated by the command.

For example, in the macro 32, if the command C4[7:0] is a write command, the serial I/F circuit 4 writes the data D[15:0] in the group of memory cells designated by the address W[15:0] in the memory 2. Alternatively, if the command C4[7:0] is a read command, the serial I/F circuit 4 reads out 16-bit data from the group of memory cells designated by the address W[15:0] in the memory 2.

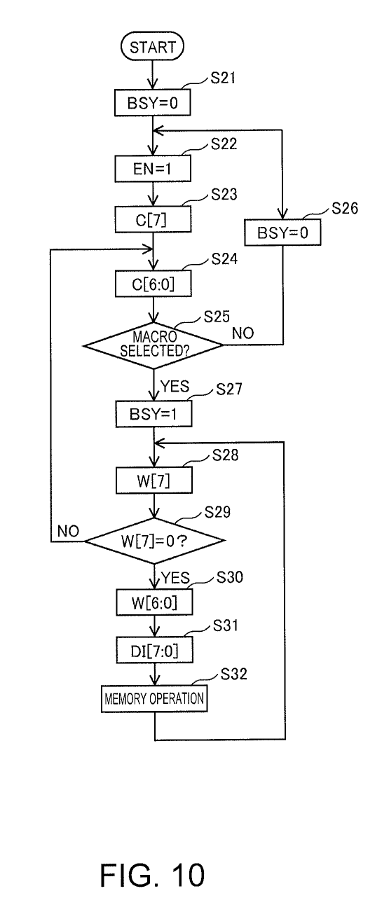

FIG. 10 is a flowchart showing the second operation example of the semiconductor integrated circuit device shown in FIG. 5. In step S21 in FIG. 10, when the power supply voltage is applied to the semiconductor integrated circuit device and the circuits in the semiconductor integrated circuit device are reset, all of the macros deactivate the busy signals BSY to the low level “0”. Thereafter, the control signal is activated.

In step S22, the control circuit 10a activates the enable signals EN supplied to all of the macros to the high level “1”. In step S23, all of the macros store the most significant bit C[7] of the command input to the serial signal input terminal. Furthermore, in step S24, all of the macros store the remaining bits C[6:0] of the command input to the serial signal input terminal.

In step S25, all of the macros determine whether or not they have been selected using the identification code included in the command C[7:0]. In the macro selected using the identification code (e.g., macro 31), the processing transitions to step S27. In step S27, the macro 31 activates the busy signal BSY1 to the high level “1”.

Thus, the control circuit 10a deactivates the enable signal EN2 supplied to the macro that was not selected using the identification code (e.g., macro 32). In the macro 32, the processing transitions to step S26, and the busy signal BSY2 is maintained at the low level “0”. Thereafter, the macro 32 stops the operation until the enable signal EN2 is activated.

Furthermore, in step S28, the serial I/F circuit 3 of the macro 31 stores the most significant bit W[7] of the address input to the serial signal input terminal. In this example, the most significant bit W[7] of the address is not for designating the address, but is used as a control code for controlling the branching of the processing. In step S29, the serial I/F circuit 3 determines whether or not the most significant bit W[7] of the address is “0”.

If the most significant bit W[7] of the address is “0”, the processing transitions to step S30. In step S30, the serial I/F circuit 3 stores the remaining bits W[6:0] of the address input to the serial signal input terminal, and thereafter, in step S31, stores the data DI[7:0] input to the serial signal input terminal.

In step S32, the serial I/F circuit 3 causes the memory 1 to operate. For example, the serial I/F circuit 3 writes the data DI[7:0] in the group of memory cells designated by the address W[6:0] in the memory 1. Thereafter, the processing returns to step S28.

In step S28, the serial I/F circuit 3 stores the most significant bit W[7] of the address input to the serial signal input terminal. In step S29, the serial I/F circuit 3 determines whether or not the most significant bit W[7] of the address is “0”.

If the most significant bit W[7] of the address is “0”, steps S30 to S32 are repeated, and the data is written in the memory 1. On the other hand, if the most significant bit W[7] of the address is “1”, the processing returns to step S24. In step S24, the serial I/F circuit 3 stores the remaining bits C[6:0] of the command input to the serial signal input terminal.

In step S25, the serial I/F circuit 3 determines whether or not the macro 31 has been selected using the identification code included in the command C[7:0]. If the macro 31 has been selected using the identification code, the processing transitions to step S27, and the serial I/F circuit 3 maintains the busy signal BSY1 at the high level “1”.

In step S28, the serial I/F circuit 3 stores the most significant bit W[7] of the address input to the serial signal input terminal. In step S29, the serial I/F circuit 3 determines whether or not the most significant bit W[7] of the address is “0”.

If the most significant bit W[7] of the address is “0”, the processing transitions to step S30. In step S30, the serial I/F circuit 3 stores the remaining bits W[6:0] of the address input to the serial signal input terminal, and thereafter, in step S31, stores the data DI[7:0] input to the serial signal input terminal.

In step S32, the serial I/F circuit 3 causes the memory 1 to operate. For example, the serial I/F circuit 3 reads out 8-bit data from the group of memory cells designated by the address W[6:0] in the memory 1. Thereafter, the processing returns to step S28.

In step S28, the serial I/F circuit 3 stores the most significant bit W[7] of the address input to the serial signal input terminal. In step S29, the serial I/F circuit 3 determines whether or not the most significant bit W[7] of the address is “0”.

If the most significant bit W[7] of the address is “0”, steps S30 to S32 are repeated, and the data is read out from the memory 1. On the other hand, if the most significant bit W[7] of the address is “1”, the processing returns to step S24. In step S24, the serial I/F circuit 3 stores the remaining bits C[6:0] of the command input to the serial signal input terminal.

In step S25, the serial I/F circuit 3 determines whether or not the macro 31 has been selected using the identification code included in the command C[7:0]. If the macro 31 has not been selected using the identification code, the processing transitions to step S26, and the serial I/F circuit 3 deactivates the busy signal BSY1 to the low level “0”. Thereafter, the processing returns to step S22.

In step S22, the control circuit 10a activates the enable signals EN supplied to all of the macros to the high level “1”. In step S23, all of the macros store the most significant bit C[7] of the command input to the serial signal input terminal. Furthermore, in step S24, all of the macros store the remaining bits C[6:0] of the command input to the serial signal input terminal.

In step S25, all of the macros determine whether or not they have been selected using the identification code included in the command C[7:0]. In the macro selected using the identification code (e.g., macro 32), the processing transitions to step S27. In step S27, the macro 32 activates the busy signal BSY2 to the high level “1”.

Thus, the control circuit 10a deactivates the enable signal EN1 to be supplied to the macro that was not selected using the identification code (e.g., macro 31). In the macro 31, the processing transitions to step S26, and the busy signal BSY1 is maintained at the low level “0”. Thereafter, the macro 31 stops operation until the enable signal EN1 is activated.

Furthermore, in steps S28 to S31, the serial I/F circuit 4 of the macro 32 stores the address and data input to the serial signal input terminal, and thereafter, in step S32, the serial I/F circuit 4 causes the memory 2 to operate. Steps S28 to S32 are repeated as necessary.

FIG. 11 is a diagram showing a relationship between the serial signals and the operation contents in the second operation example of the semiconductor integrated circuit device shown in FIG. 5. The first serial signal input to the serial signal input terminal includes a command C[7:0] indicating writing in the memory 1 of the macro 31, a first address W[7:0], first data DI [7:0], a second address W[7:0], and second data DI[7:0].

When the command C[7:0], the first address W[7:0], and the first data DI[7:0] are stored in the macro 31, writing in the address 1 in the memory 1 is performed. Next, when the second address W[7:0] and the second data DI[7:0] are stored in the macro 31, writing in the address 2 in the memory 1 is performed.

The second serial signal input to the serial signal input terminal includes the most significant bit W[7] of the address indicating reading out from the memory 1 of the macro 31, the remaining bits C[6:0] of the command, the first address W[7:0], the first data DI[7:0], the second address W[7:0], and the second data DI[7:0].

When the most significant bit W[7] of the address, the remaining bits C[6:0] of the command, the first address W[7:0], and the first data DI[7:0] are stored in the macro 31, reading out from the address 1 in the memory 1 is performed. Next, when the second address W[7:0] and the second data DI[7:0] are stored in the macro 31, reading out from the address 2 in the memory 1 is performed.

The third serial signal input to the serial signal input terminal includes the most significant bit W[7] of the address indicating that the memory 1 of the macro 31 is not selected, and the remaining bits C[6:0] of the command. When the third serial signal is stored in the macro 31, the memory 1 is not selected.

The fourth serial signal input to the serial signal input terminal includes the command C[7:0] indicating writing in the memory 2 of the macro 32, the first address W[15:0], the first data DI[15:0], the second address W[15:0], and the second data DI[15:0].

When the command C[7:0], the first address W[15:0], and the first data DI[15:0] are stored in the macro 32, writing in the address 1 in the memory 2 is performed. Next, when the second address W[15:0] and the second data DI[15:0] are stored in the macro 31, writing in the address 2 in the memory 1 is performed.

The fifth serial signal input to the serial signal input terminal includes an address W[15] indicating reading out of the memory 2 of the macro 32, the remaining bits C[6:0] of the command, the first address W[15:0], the first data DI[15:0], the second address W[15:0], and the second data DI[15:0].

When the address W[15], the remaining bits C[6:0] of the command, the first address W[15:0], and the first data DI[15:0] are stored in the macro 32, reading out from the address 1 in the memory 2 is performed. Next, when the second address W[15:0] and the second data DI[15:0] are stored in the macro 31, reading out from the address 2 in the memory 2 is performed.

The sixth serial signal input to the serial signal input terminal includes the address W[15] indicating that the memory 2 of the macro 32 is not selected, and the remaining bits C[6:0] of the command. When the sixth serial signal is stored in the macro 32, the memory 2 is not selected.

According to the second operation example, data can be efficiently read from and written in memories included in macros by continuously supplying combinations of addresses and data to the macros. Also, the operation of multiple macros can be switched by supplying commands once more thereto. In this case, the commands will no longer have periodicity, but the status of control will be managed by the serial I/F circuit of the selected macro. Accordingly, the control circuit 10a does not need to always keep track of the status, and need only wait for the deactivation of the busy signal.

First example of control signal generation circuit

Next, a control signal generation circuit to be used in the semiconductor integrated circuit device according to the embodiments of the invention will be described. The control circuit 10 shown in FIG. 1 and the control circuit 10a shown in FIG. 5 preferably do not detect the activation of the control signals in the normal operation mode. In this case, in a normal operation mode, it is possible to prevent the semiconductor integrated circuit device from erroneously transitioning to the test mode in which a macro is tested. For this reason, a control signal generation circuit may be provided in the semiconductor integrated circuit device.

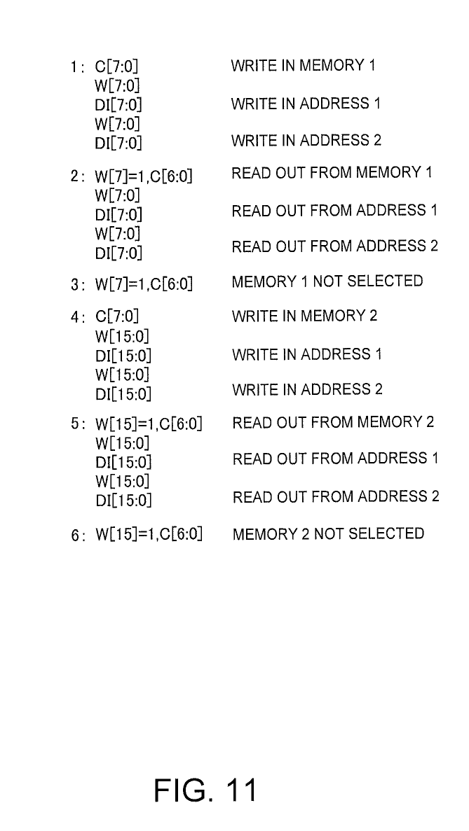

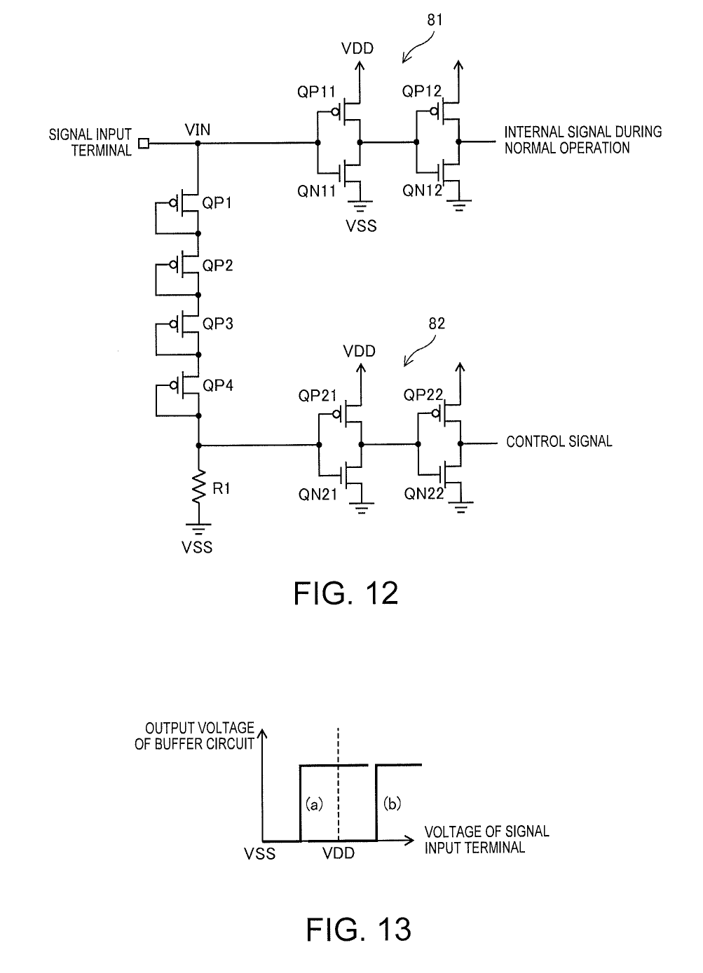

FIG. 12 is a circuit diagram showing a first example of a control signal generation circuit, and FIG. 13 is a diagram for illustrating an operation of the control signal generation circuit shown in FIG. 12. In the first example, when the difference between a voltage VIN applied to a signal input terminal (e.g., input terminals P1 to P3 shown in FIG. 1) and a high-potential-side power supply voltage VDD is greater than a predetermined value, the control signal generation circuit activates the control signal to the high level.

As shown in FIG. 12, for example, the control signal generation circuit includes buffer circuits 81 and 82, P-channel MOS transistors QP1 to QP4, and a resistor R1. The buffer circuit 81 includes a first inverter constituted by a P-channel MOS transistor QP11 and an N-channel MOS transistor QN11, and a second inverter constituted by a P-channel MOS transistor QP12 and an N-channel MOS transistor QN12.

Also, the buffer circuit 82 includes a third inverter constituted by a P-channel MOS transistor QP21 and an N-channel MOS transistor QN21, and a fourth inverter constituted by a P-channel MOS transistor QP22 and an N-channel MOS transistor QN22. The buffer circuits 81 and 82 operate by receiving supply of the high-potential-side power supply voltage VDD (e.g., 2 V) and a low-potential-side power supply voltage VSS (e.g., grounding voltage 0 V).

The input terminal of the buffer circuit 81 is connected to the signal input terminal. Also, the transistors QP1 to QP4 are connected in series between the signal input terminal and the input terminal of the buffer circuit 82, and the resistor R1 is connected between the input terminal of the buffer circuit 82 and the interconnect of the power supply voltage VSS.

In the normal operation mode, the signal applied to the signal input terminal transitions between the power supply voltage VDD and the power supply voltage VSS. Accordingly, as shown in FIG. 13, the buffer circuit 81 buffers the signal applied to the signal input terminal and outputs an internal signal (a) during normal operation. On the other hand, because the transistors QP1 to QP4 are off, the power supply voltage VSS is applied to the input terminal of the buffer circuit 82. Accordingly, the buffer circuit 82 outputs a control signal (b) that is deactivated to the low level.

In the test mode, if the difference between the voltage VIN applied to the signal input terminal and the high-potential-side power supply voltage VDD is made greater than a predetermined value (e.g., around 0.4 V), the transistors QP1 to QP4 turn on. Thus, a voltage at a high level is applied to the input terminal of the buffer circuit 82. Accordingly, as shown in FIG. 13, the buffer circuit 82 outputs the control signal (b) that has been activated to the high level.

Second example of control signal generation circuit

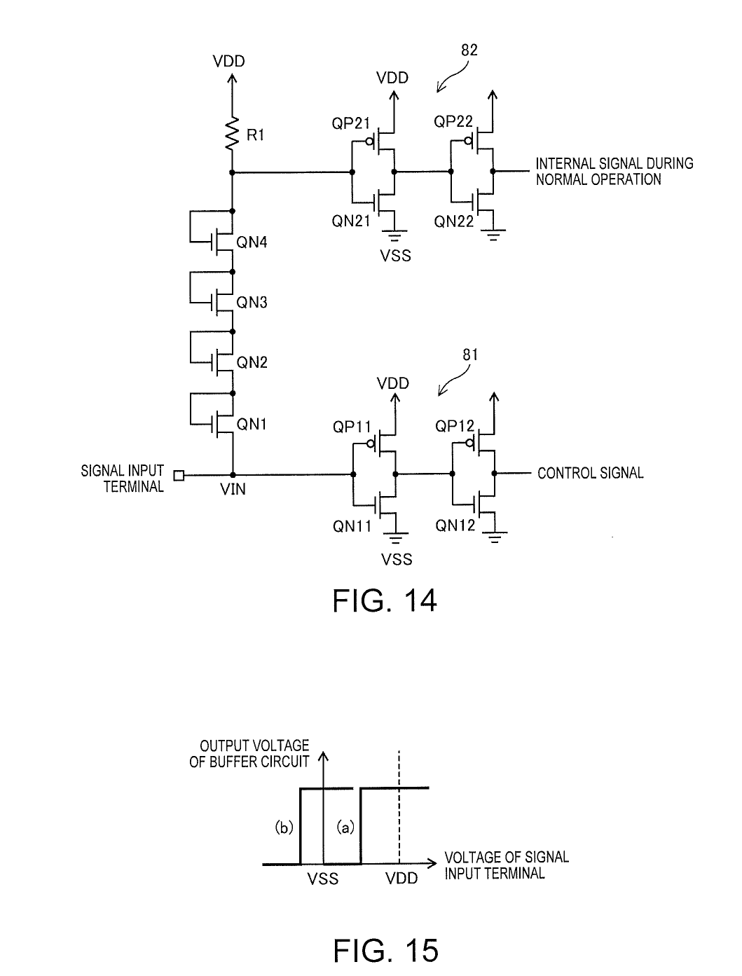

FIG. 14 is a circuit diagram showing a second example of a control signal generation circuit, and FIG. 15 is a diagram for illustrating an operation of the control signal generation circuit shown in FIG. 14. In the second example, the control signal generation circuit activates the control signal when the difference between the low-potential-side power supply voltage VSS and the voltage VIN applied to the signal input terminal (e.g., the input terminals P1 to P3 shown in FIG. 1) is greater than a predetermined value.

As shown in FIG. 14, for example, the control signal generation circuit includes buffer circuits 81 and 82, N-channel MOS transistors QN1 to QN4, and a resistor R1. The buffer circuits 81 and 82 operate by receiving supply of the high-potential-side power supply voltage VDD (e.g., 2 V) and a low-potential-side power supply voltage VSS (e.g., grounding voltage 0 V).

The input terminal of the buffer circuit 81 is connected to the signal input terminal. Also, the transistors QN1 to QN4 are connected in series between the signal input terminal and the input terminal of the buffer circuit 82, and the resistor R1 is connected between the input terminal of the buffer circuit 82 and the interconnect of the power supply voltage VDD.

In the normal operation mode, the signal applied to the signal input terminal transitions between the power supply voltage VDD and the power supply voltage VSS. As shown in FIG. 15, the buffer circuit 81 buffers the signal applied to the signal input terminal and outputs an internal signal (a) at a time of normal operation. On the other hand, because the transistors QN1 to QN4 are off, the power supply voltage VDD is applied to the input terminal of the buffer circuit 82. Accordingly, the buffer circuit 82 outputs a control signal (b) that is deactivated to the high level.

In the test mode, if the difference between the low-potential-side power supply voltage VSS and the voltage VIN applied to the signal input terminal is made greater than a predetermined value (e.g., around 0.4 V), the transistors QN1 to QN4 turn on, and a voltage at a low level is applied to the input terminal of the buffer circuit 82. Accordingly, as shown in FIG. 15, the buffer circuit 82 outputs the control signal (b) that has been activated to the low level.

Thus, according to the first and second examples of the control signal generation circuit, even without newly providing a control signal input terminal, it is possible to cause the semiconductor integrated circuit device to transition to the test mode by merely controlling the voltage applied to the signal input terminal that is already present.

Third Example of Control Signal Generation Circuit

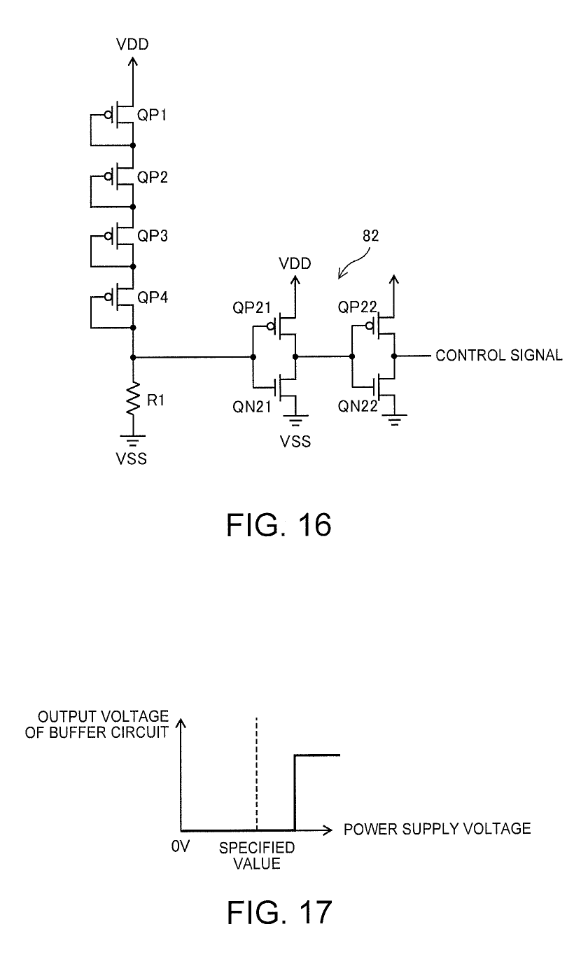

FIG. 16 is a circuit diagram showing a third example of a control signal generation circuit, and FIG. 17 is a diagram for illustrating an operation of the control signal generation circuit shown in FIG. 16. In the third example, the control signal generation circuit activates the control signal when the applied power supply voltage (VDD-VSS) is greater than a predetermined value.

As shown in FIG. 16, for example, the control signal generation circuit includes a buffer circuit 82, P-channel MOS transistors QP1 to QP4, and a resistor R1. The buffer circuits 81 and 82 operate by receiving supply of the high-potential-side power supply voltage VDD (e.g., 2 V) and a low-potential-side power supply voltage VSS (e.g., grounding voltage 0 V). Also, the transistors QP1 to QP4 are connected in series between the interconnect of the power supply voltage VDD and the input terminal of the buffer circuit 82, and the resistor R1 is connected between the input terminal of the buffer circuit 82 and the interconnect of the power supply voltage VSS.

In the normal operation mode, the power supply voltage (VDD-VSS) is a specified value (e.g., 2 V). Because the transistors QP1 to QP4 are off, the power supply voltage VSS is applied to the input terminal of the buffer circuit 82. Accordingly, as shown in FIG. 17, the buffer circuit 82 outputs the control signal that has been deactivated to the low level.

In the test mode, when the power supply voltage (VDD-VSS) is made larger than a predetermined value (e.g., around 2.4 V, which is 4 times a threshold voltage of a P-channel MOS transistor), the transistors QP1 to QP4 turn on, and the high-level voltage is applied to the input terminal of the buffer circuit 82. Accordingly, as shown in FIG. 17, the buffer circuit 82 outputs the control signal that has been activated to the high level. Thus, according to the third example of the control signal generation circuit, even without newly providing a control signal input terminal, it is possible to cause the semiconductor integrated circuit device to transition to the test mode by merely controlling the power supply voltage.

Electronic Apparatus

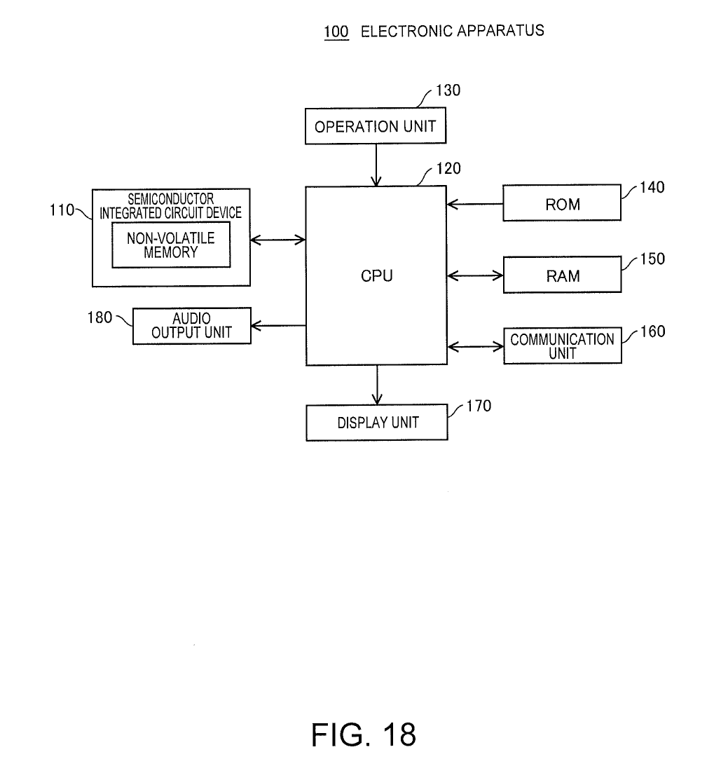

Next, an electronic apparatus according to an embodiment of the invention will be described with reference to FIG. 18.

FIG. 18 is a block diagram showing a configuration example of an electronic apparatus according to an embodiment of the invention. An electronic apparatus 100 may include the semiconductor integrated circuit device 110 according to an embodiment of the invention, a CPU 120, an operation unit 130, a ROM (Read-Only Memory) 140, a RAM (Random Access Memory) 150, a communication unit 160, a display unit 170, and an audio output unit 180. Note that a portion of the constituent elements shown in FIG. 18 may be omitted or changed, or another constituent element may be added to the constituent elements shown in FIG. 18.

The semiconductor integrated circuit device 110 includes a non-volatile memory in at least one macro and performs various types of processing in response to commands from the CPU 120. For example, the semiconductor integrated circuit device 110 corrects input data and converts the format of data based on parameters stored in the non-volatile memory.

The CPU 120 performs various types of operational processing and control processing using data and the like supplied from the semiconductor integrated circuit device 110, in accordance with a program stored in the ROM 140 or the like. For example, the CPU 120 performs various types of data processing in response to an operation signal supplied from the operation unit 130, controls the communication unit 160 in order to perform data communication with an external device, generates an image signal in order to cause the display unit 170 to display various images, and generates an audio signal for causing the audio output unit 180 to output various types of audio.

The operation unit 130 is, for example, an input device including operation keys, button switches, and the like, and outputs an operation signal corresponding to an operation performed by a user to the CPU 120. The ROM 140 stores programs, data, and the like in order for the CPU 120 to perform various types of calculation processing and control processing. Also, the RAM 150 is used as a work region of the CPU 120 and temporarily stores programs and data read out from the ROM 140, data input using the operation unit 130, results of calculations executed by the CPU 120 in accordance with a program, or the like.

For example, the communication unit 160 is constituted by an analog circuit or a digital circuit and performs data communication between the CPU 120 and an external device. For example, the display unit 170 includes an LCD (liquid crystal display device) and the like and displays various types of information based on a display signal supplied from the CPU 120. Also, the audio output unit 180 includes speakers and the like, for example, and outputs audio based on an audio signal supplied from the CPU 120.

Examples of the electronic apparatus 100 include a calculator, an electronic dictionary, an electronic game apparatus, a mobile terminal such as a mobile phone, a digital still camera, a digital movie camera, a television, a video phone, a security television monitor, a head-mounted display, a personal computer, a printer, a network apparatus, a car navigation device, a measurement apparatus, a medical apparatus (e.g., an electronic thermometer, a blood pressure monitor, a blood sugar monitor, an electrocardiographic device, an ultrasonic diagnostic device, and an electronic endoscope), and the like.

According to the present embodiment, it is possible to provide an electronic apparatus according to which it is easier to control a serial interface operation of a macro (including a non-volatile memory) embedded in a semiconductor integrated circuit device 110. For example, storing a program in a non-volatile memory of the semiconductor integrated circuit device 110 makes it possible to omit the ROM 140, and storing data in the non-volatile memory of the semiconductor integrated circuit device 110 makes it possible to omit the RAM 150.

The above-described embodiments described a case in which a macro embedded in the semiconductor integrated circuit device includes a memory, but the invention is not limited to the above-described embodiments and can be modified in many ways by a person reasonably skilled in the art, without straying from the technical idea of the invention.

The entire disclosure of Japanese Patent Application No. 2015-051769, filed Mar. 16, 2015 is expressly incorporated by reference herein.

What is claimed is:

1. A semiconductor integrated circuit device comprising:
a serial signal input terminal configured to receive input of a command;
a control signal input terminal configured to receive input of a control signal; and
a circuit block configured to, if the control signal is activated, determine whether or not the circuit block has been selected using an identification code included in the command, and if it is determined that the circuit block has been selected using the identification code, perform an operation designated by the command.

2. The semiconductor integrated circuit device according to claim 1, further comprising
a control circuit,
wherein the circuit block activates a busy signal when an enable signal is activated, determines whether or not the circuit block has been selected using the identification code when the enable signal is activated, and if it is determined that the circuit block has been selected using the identification code, the circuit block maintains the activation of the busy signal for at least a period during which a series of serial signals are input thereto and performs the operation designated by the command, and
the control circuit activates the enable signal when the control signal is activated, and deactivates the enable signal when the busy signal is deactivated.

3. The semiconductor integrated circuit device according to claim 1, further comprising
a control circuit,
wherein the circuit block activates a busy signal when an enable signal is activated, and determines whether or not the circuit block has been selected using the identification code when the enable signal is activated, and if it is determined that the circuit block has been selected using the identification code, the circuit block activates the busy signal for at least a period during which a series of serial signals are input thereto and performs the operation designated by the command, and
the control circuit activates the enable signal when the control signal is activated, and deactivates the enable signal when the busy signal is deactivated.

4. The semiconductor integrated circuit device according to claim 2, wherein
if it is determined that the circuit block has been selected using the identification code, the circuit block deactivates the busy signal upon elapse of a period during which a series of serial signals are input thereto.

5. The semiconductor integrated circuit device according to claim 2, wherein
if it is determined that the circuit block has been selected using the identification code, the circuit block deactivates the busy signal after the operation designated by the command ends.

6. The semiconductor integrated circuit device according to claim 2, wherein
if it is determined that the circuit block has been selected using the identification code, when the enable signal is activated, the circuit block determines whether or not the circuit block has been selected using a second identification code included in a second command input to the serial signal input terminal, and if it is determined that the circuit block has not been selected using the identification code, the circuit block deactivates the busy signal.

7. The semiconductor integrated circuit device according to claim 1, further comprising:
a first circuit block configured to determine whether or not the first circuit block has been selected using the identification code when a first enable signal is activated, and if it is determined that the first circuit block has been selected using the identification code, the first circuit block activates a first busy signal for at least a period during which a series of serial signals are input thereto, and performs an operation designated by the command;
a second circuit block configured to determine whether or not the second circuit block has been selected using the identification code when a second enable signal is activated, and if it is determined that the second circuit block has been selected using the identification code, the second circuit block activates a second busy signal for at least a period during which a series of serial signals are input thereto, and performs an operation designated by the command; and
a control circuit configured to deactivate a second enable signal when a first busy signal is activated and deactivate a first enable signal when a second busy signal is activated.

8. The semiconductor integrated circuit device according to claim 1, wherein
the activation of the control signal is not detected in a normal operation mode.

9. The semiconductor integrated circuit device according to claim 1, further comprising
a control signal generation circuit configured to transmit the control signal when a difference between a voltage applied to a signal input terminal and a high-potential-side power supply voltage is greater than a predetermined value, or when a difference between a low-potential-side power supply voltage and a voltage applied to a signal input terminal is greater than a predetermined value.

10. The semiconductor integrated circuit device according to claim 1, further comprising
a control signal generation circuit configured to transmit the control signal when an applied power supply voltage is greater than a predetermined value.

11. An electronic apparatus comprising
the semiconductor integrated circuit device according to claim 1.

12. A control method for a circuit, comprising:
determining, in a case where an input control signal is activated, whether or not the circuit has been selected using an identification code included in an input command; and
performing an operation designated by the command in a case where it is determined that the circuit has been selected using the identification code.
